(19) United States
(12) Patent Application Publication
(10) Pub. No.: US 2016/0216847 A1
(43) Pub. Date: Jul. 28, 2016

(54) COMPUTER PRODUCT, SCREEN CONTROL APPARATUS, AND SCREEN CONTROL METHOD

(71) Applicant: FUJITSU LIMITED, Kawasaki-shi (JP)

(72) Inventors: Makoto HONDA, Odawara (JP); Naoki SAKIYAMA, Setagaya (JP)

(73) Assignee: FUJITSU LIMITED, Kawasaki-shi (JP)

(21) Appl. No.: 15/091,623

(22) Filed: Apr. 6, 2016

Related U.S. Application Data
(63) Continuation of application No. PCT/JP2013/078379, filed on Oct. 18, 2013.

(51) Int. Cl. G06F 3/0481; G06F 3/0488; G06Q 10/10; G06F 3/0485

(52) U.S. Cl. CPC G06F 3/0481; G06F 3/0485; G06F 3/0488; G06Q 10/1095

(57) ABSTRACT

A non-transitory, computer-readable recording medium stores therein a screen control program that causes a computer to execute a process that includes performing when a predetermined operation is detected during display of a first calendar screen or a second calendar screen, screen control of changing a date of a calendar screen to be displayed, by a changing scheme that differs according to whether a displayed calendar screen is the first calendar screen or the second calendar screen. The computer is configured to switch display of the first calendar screen by which dates are aligned chronologically in a vertical direction enabling scrolling and the second calendar screen in which the dates are arranged according to days of a week in a horizontal direction and chronologically in a vertical direction in a lattice.

### CROSS REFERENCE TO RELATED APPLICATIONS

This application is a continuation application of International Application PCT/JP2013/078379, filed on Oct. 18, 2013 and designating the U.S., the entire contents of which are incorporated herein by reference.

### FIELD

The embodiments discussed herein are related to a computer product, a screen control apparatus, and a screen control method.

### BACKGROUND

Conventionally, there are techniques that enable a lattice calendar screen and a vertical calendar screen to be switched and displayed on a display. A lattice calendar screen is a calendar screen in which dates are arranged in a lattice, in units of months. Lattice calendar screens have a trait in that while information can be comprehended at a glance, to maintain the ease of comprehension, lattice calendar screens cannot display a lot of information for each day.

On the other hand, vertical calendar screens are calendar screens by which dates are aligned vertically enabling scrolling. Even when there is a lot of information for each date, a vertical calendar screen enables information that cannot fit on a single screen to be displayed by scrolling and therefore, has a trait in that operability during viewing does not degrade easily and lots of information can be input for each day.

For example, a related technique enables selection between a sender mode that enables operation of calendar software on the sender side and a user mode that enables operation of the calendar software on the user side. Under the sender mode, an event on the sender side is input and edited according to year, month, and/or day, and uploaded to a server from the sender side. Under the user mode, an event on the sender side and downloaded from the server is displayed in the corresponding location of year, month, and day. For example, refer to Japanese Laid-Open Patent Publication No. 2001-297173.

Nonetheless, with the conventional technique, when the lattice calendar screen and the vertical calendar screen are used based on such traits to reference different information, the number of operations that have to be performed until the information of a specified date desired by the user is displayed increases, inviting a drop in user convenience.

### SUMMARY

According to an aspect of an embodiment, a non-transitory, computer-readable recording medium stores therein a screen control program that causes a computer to execute a process that includes performing when a predetermined operation is detected during display of a first calendar screen or a second calendar screen, screen control of changing a date of a calendar screen to be displayed, by a changing scheme that differs according to whether a displayed calendar screen is the first calendar screen or the second calendar screen. The computer is configured to switch display of the first calendar screen by which dates are aligned chronologically in a vertical direction enabling scrolling and the second calendar screen in which the dates are arranged according to days of a week in a horizontal direction and chronologically in a vertical direction in a lattice.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a screen control method according to a first embodiment;

FIG. 2 is a diagram depicting an example of system configuration of a system 200;

FIG. 3 is a block diagram of an example of hardware configuration of a screen control apparatus 201;

FIG. 4 is a block diagram of an example of hardware configuration of a communications terminal apparatus 202;

FIG. 5 is a block diagram of an example of a functional configuration of the screen control apparatus 201;

FIGS. 6, 7, 8, and 9 are diagrams depicting an example of calendar screen transition; and

FIG. 10 is a flowchart of a screen control process of the screen control apparatus 201.

### DESCRIPTION OF EMBODIMENTS

Embodiments of a screen control program, a screen control apparatus, and a screen control method according to the present disclosure will be described in detail with reference to the accompanying drawings.

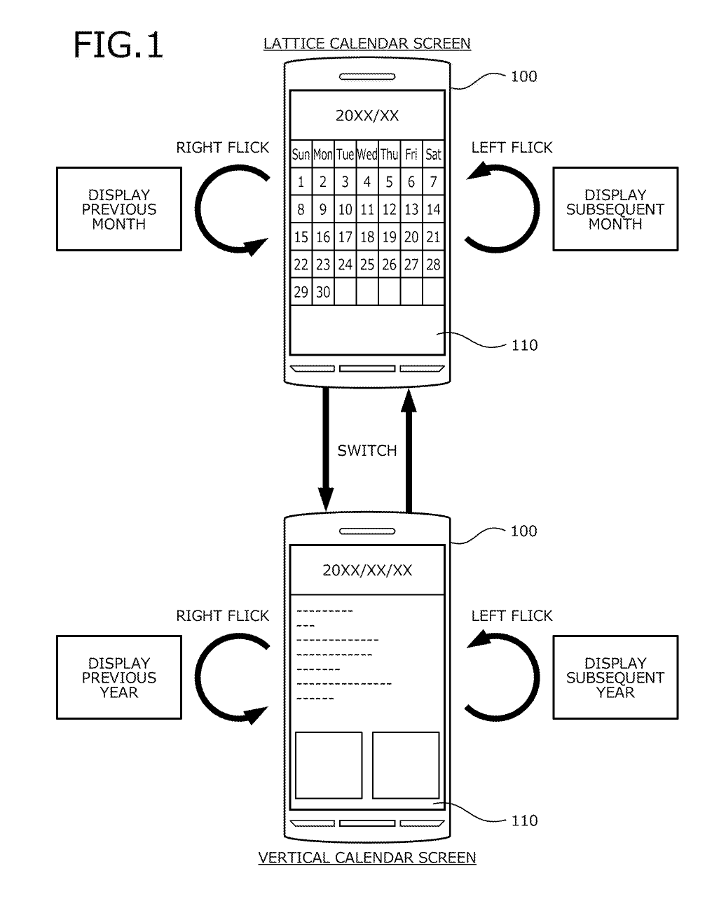

FIG. 1 is a diagram depicting an example of the screen control method according to a first embodiment. In FIG. 1, a screen control apparatus 100 has a display 110 and is a computer that can switch and control the display of a first calendar screen and a second calendar screen.

More specifically, for example, the screen control apparatus 100 is a smartphone, a mobile telephone, a tablet personal computer (PC), a Personal Handy-phone System (PHS) device, a note PC, a PC, and the like. Further, the display 110, for example, is a touch panel display that integrates a display apparatus and an input apparatus.

Here, first calendar screens are calendar screens by which dates are aligned chronologically in a vertical direction enabling scrolling. A date is a day of a month or year as specified by a number. A second calendar screen is a calendar screen in which dates are arranged according to the sequence of the days of the week in a horizontal direction and chronologically in a vertical direction of a lattice.

In the description hereinafter, a first calendar screen may be denoted as a “vertical calendar screen” and a second calendar screens may be denoted as a “lattice calendar screen”.

A lattice calendar screen is configured in units of months and has a trait in that while the ease of comprehension concerning multiple dates is high, to maintain the ease of comprehension, the lattice calendar cannot display a lot of information for each date. Therefore, a lattice calendar screen is suitable in cases where general information for each day of a specified interval is output on a screen.

On the other hand, when there is a lot of information for each day, a vertical calendar screen enables information that cannot fit on a single screen to be displayed by vertical scrolling and therefore, has a trait in that operability during viewing does not easily degrade and a lot of information can be input for each date. As a result, a vertical calendar screen is suitable in cases where detailed information for one day is output on a screen.

For example, when a lattice calendar screen is used for management when a crop is cultivated, the lattice calendar screen is suitable for displaying general work plans for each day of a specified interval. On the other hand, a vertical calendar screen is suitable for displaying specific information related to farm work of each day.

Specific information related to farm work, for example, includes information such as images taken of fields or crops, the growth state of crops, farm equipment, pesticides, fertilizers, etc. used in the farm work. Therefore, when the user uses a lattice calendar screen and a vertical calendar screen for management when a crop is cultivated, viewing of a lattice calendar screen and a vertical calendar screen to reference different information is assumed.

More specifically, when a lattice calendar screen is viewed, the user often wants to confirm general work plans in the near future or for a day in the past. Therefore, in displaying a lattice calendar screen, it is desirable to enable past information or information for the near future to be output on a screen simply and by fewer operations.

On the other hand, when a vertical calendar screen is viewed, the user often wants to confirm specific information related to farm work of a specified day. Further, in agriculture, for farm work of a specified day, past information concerning the same farm work often serves as a reference. For example, when a specified crop is cultivated at 1-year cycles, work contents of the same interval of another year serve as a reference for farm work of a specified day.

For example, the user can determine whether the state of growth of the current crop is good or bad from an image of the crop during the same interval of the previous year, or can determine the type of pesticide to be sprayed from the name of the pesticide sprayed during the same interval of the previous year. Therefore, in displaying the vertical calendar screen, it is desirable to enable information for the same interval of another year to be output on a screen simply and by fewer operations.

However, irrespective of whether the displayed calendar screen is a lattice calendar screen or a vertical calendar screen, when the scheme of changing a date in response to a given operation is the same, the number of operations that have to be performed until the information of a specified date desired by the user is displayed increases and user convenience may drop.

For example, a case is assumed where irrespective of whether the displayed calendar screen is a lattice calendar screen or a vertical calendar screen, when a given operation is performed, the date of the calendar screen displayed changes to the date of the previous month. In this case, when a vertical calendar screen is being displayed, a given operation has to be performed 12 times to display information for a date 1 year before the current date.

Thus, in the first embodiment, a screen control method will be described that changes the scheme of changing the date of a calendar screen in response to a given operation, depending on whether the calendar screen being displayed on the display 110 is a vertical calendar screen or a lattice calendar screen. Hereafter, an example of the screen control method of the screen control apparatus 100 will be described.

(1) The screen control apparatus 100 detects a predetermined operation in a vertical calendar screen or a lattice calendar screen being displayed. Here, the predetermined operation is an operation for transitioning the display contents of the display 110 to a calendar screen of another date different from the date of the calendar screen being displayed.

Operation contents of the predetermined operation can be set arbitrarily. For example, in a case where the display 110 is a touch panel, a horizontal flick, a diagonal flick, the pressing of a specified button, etc. can be set as the predetermined operation. Further, the pressing of a specified physical button provided on the screen control apparatus 100 may be set as the predetermined operation.

In the example depicted in FIG. 1, the screen control apparatus 100 detects a horizontal flick during the display of a vertical calendar screen or a lattice calendar screen as the predetermined operation. A flick is an operation of sliding a screen by a finger or pen. Horizontal flicks include a flick towards the right (right flick) and a flick towards the left (left flick).

(2) The screen control apparatus 100, upon detecting the predetermined operation, performs screen control of changing the date of the calendar screen to be displayed, by a changing scheme that differs depending on whether the calendar screen being displayed is a vertical calendar screen or a lattice calendar screen.

A case will be described where the displayed calendar screen is a vertical calendar screen. In this case, the screen control apparatus 100, upon detecting the predetermined operation during display of a vertical calendar screen, performs screen control of changing the date of the displayed information to a date that is before the date of the display information, by an interval T1, or a date that is after the date of the displayed information, by the interval T1.

Here, the interval T1 is an interval that differs from an interval T2 described hereinafter, and can be arbitrarily set. As described above, when a specified crop is cultivated at 1-year cycles, the work contents of the same interval of another year serve as a reference for the farm work of a specified day. Therefore, the interval T1, for example, is set according to the cultivation cycle of the crop.

The cultivation cycle is the cycle at which the same crop is repeatedly cultivated and, for example, is an interval from the sowing of seeds of the crop (or planting of seedlings) until harvesting of the crop. The cultivation cycle may differ according to the type of crop. Therefore, the cultivation cycle corresponding to the type of crop to be cultivated, for example, 3 months, half a year, 1 year, etc., is set as the interval T1.

In the example depicted in FIG. 1, since the cultivation cycle of the crop is 1 year, the interval T1 is assumed to be set as “1 year”. In this case, the screen control apparatus 100, upon detecting a right flick during display of a vertical calendar screen, performs screen control of changing to the same month and day of the previous year, the same month and day as that of the vertical calendar screen being displayed. Further, the screen control apparatus 100, upon detecting a left flick during display of a vertical calendar screen, performs screen control of changing to the same month and day of the subsequent year.

Here, “2013/10/01” is assumed as an example of the date of the displayed information. The screen control apparatus 100, upon detecting a right flick during display of a vertical calendar screen, generates screen information for a vertical calendar screen for “2012/10/01” and displays the vertical calendar screen on the display 110.

A case where the calendar screen being displayed is a lattice calendar screen will be described. In this case, the screen control apparatus 100, upon detecting the predetermined operation during the display of a lattice calendar screen, performs screen control of changing to a date of a month that is before the month of the displayed lattice calendar screen, by the interval T2, or a date of a month that is after the month of the displayed lattice calendar screen, by the interval T2.

Here, the interval T2 is an interval that differs from the interval T1, and can be arbitrarily set. As described above, when a lattice calendar screen is viewed, the user wants to view general work plans for a day in the near future or in the past. Therefore, the interval T2, for example, is set to an interval of about 1 or 2 months.

In the example depicted in FIG. 1, the interval T2 is assumed to be set as “1 month”. In this case, the screen control apparatus 100, upon detecting a right flick during display of a lattice calendar screen, performs screen control of changing to a date of the month before the month of the information being displayed. Further, the screen control apparatus 100, upon detecting a left flick during display of the lattice calendar screen, performs screen control of changing to a date of the month subsequent to the month of the information being displayed.

Here, “2013/10/01-2013/10/31” is assumed as an example of the dates of the information being displayed. The screen control apparatus 100, upon detecting a left flick during display of the lattice calendar screen, generates screen information for a lattice calendar screen for “2013/11/01-2013/11/30” and displays the lattice calendar screen on the display 110.

As described above, according to the screen control apparatus 100 of the first embodiment, the scheme of changing the date of the calendar screen in response to a horizontal flick, can be changed according to whether the calendar screen being displayed is a vertical calendar screen or a lattice calendar screen.

As a result, when the lattice calendar screen and the vertical calendar screen are used based on respective traits to reference different information, fewer operations are performed until the information of a specified date desired by the user is displayed, enabling improved user convenience. Further, since fewer operations are performed until the information of a specified date desired by the user is displayed, the processing load of the screen control apparatus 100 for display control of the display 110 is reduced, enabling power consumption to be suppressed.

An example of system configuration of a system 200 according to a second embodiment will be described. In the second embodiment, description will be given taking a case where functions of the screen control apparatus 100 described in the first embodiment are applied to a screen control apparatus 201 in the system 200. Portions identical to those described in the first embodiment are given the same reference numerals used in the first embodiment and description thereof is omitted hereinafter.

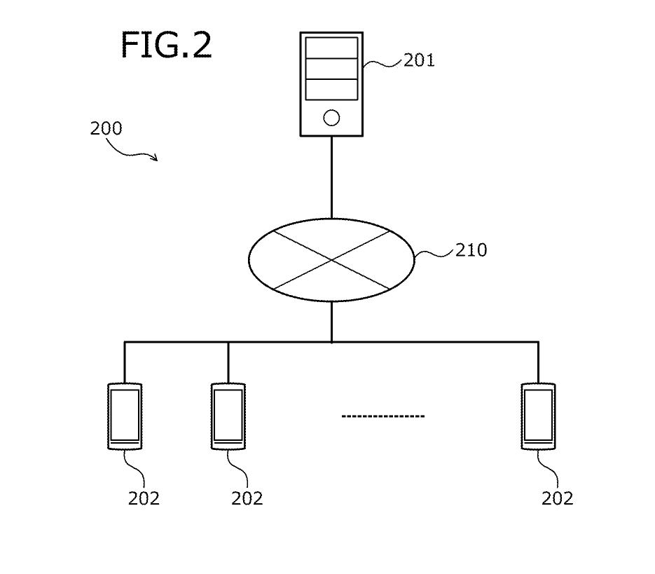

FIG. 2 is a diagram depicting an example of system configuration of the system 200. In FIG. 2, the system 200 includes the screen control apparatus 201 and plural communications terminal apparatuses 202. In the system 200, the screen control apparatus 201 and the communications terminal apparatuses 202 are connected through a wired or wireless the network 210. The network 210, for example, is a local area network (LAN), a wide area network (WAN), the Internet, etc.

Here, the screen control apparatus 201 is a computer that performs screen control of the communications terminal apparatuses 202. The screen control apparatus 201, for example, is a server. The screen control apparatus 201 receives event information from the communications terminal apparatuses 202, and generates and transmits to the communications terminal apparatuses 202, screen information corresponding to the received event information.

Event information is information that indicates an operation event of the communications terminal apparatuses 202. An operation event, for example, includes various actions such as touching, flicking, scrolling, the pressing of a button, etc. Screen information, for example, is screen information such as for a calendar screen, a login screen, a logout screen, and the like.

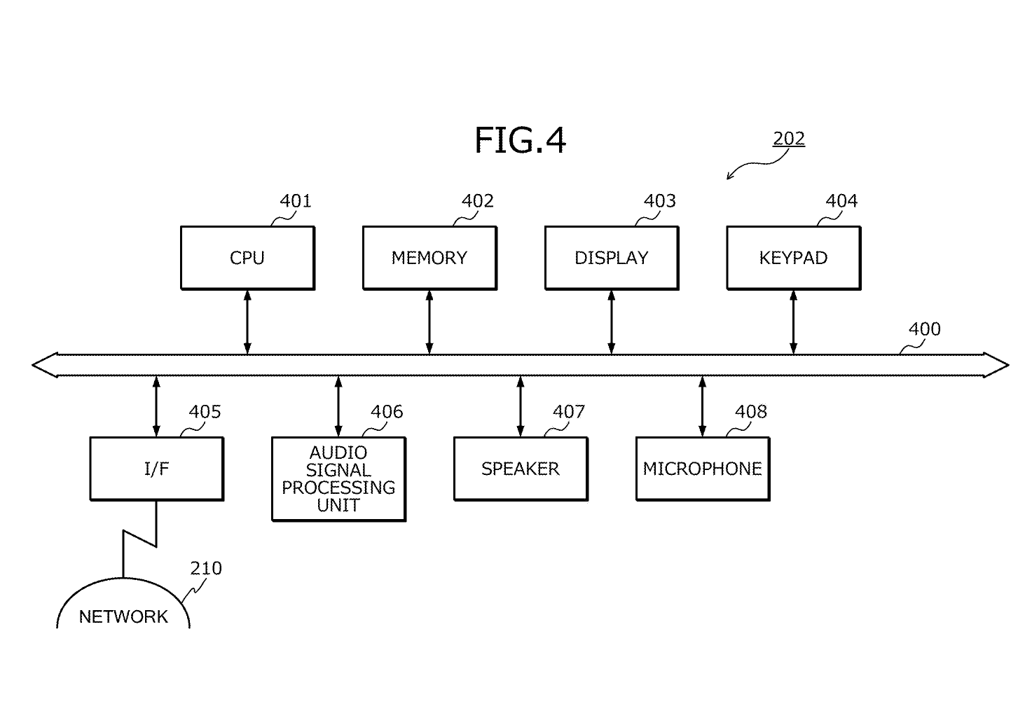

The communications terminal apparatuses 202 respectively have a touch panel display (e.g., a display 403 depicted in FIG. 4, described hereinafter), and are computers that under the screen control of the screen control apparatus 201, can switch and display a vertical calendar screen and a lattice calendar screen. The communications terminal apparatuses 202, for example, are smartphones, mobile telephones, tablet PCs, PHS devices, and the like.

The communications terminal apparatuses 202 receive an operation event by user input, and transmit event information concerning the received operation event to the screen control apparatus 201. The communications terminal apparatuses 202 receive from the screen control apparatus 201, screen information that corresponds to the transmitted event information and display the received screen information on the display.

In the system 200, the screen control apparatus 201, for example, in response to a login operation by a user of a communications terminal apparatus 202, begins screen control for the communications terminal apparatus 202. Further, the screen control apparatus 201, in response to a logout operation by the user of the communications terminal apparatus 202, ends screen control for the communications terminal apparatus 202.

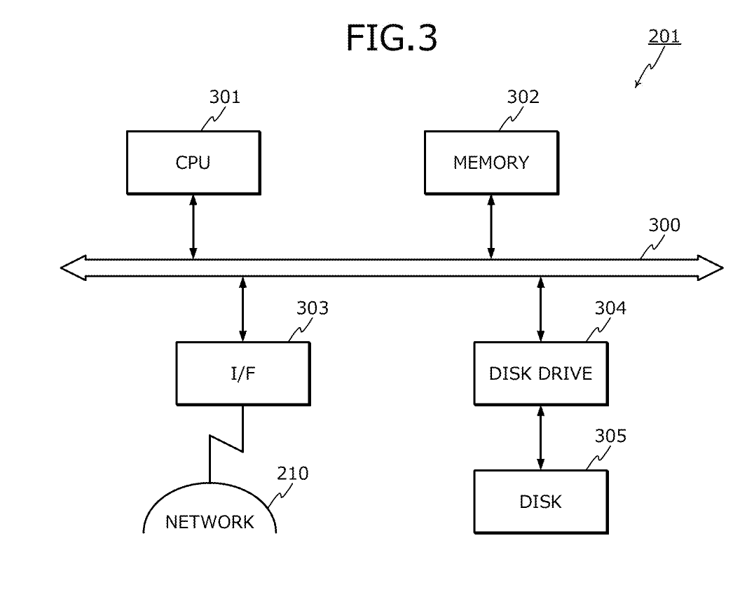

FIG. 3 is a block diagram of an example of hardware configuration of the screen control apparatus 201. In FIG. 3, the screen control apparatus 201 has a central processing unit (CPU) 301, memory 302, an interface (I/F) 303, a disk drive 304, and a disk 305, respectively connected by a bus 300.

Here, the CPU 301 governs overall control of the screen control apparatus 201. The memory 302, for example, includes read-only memory (ROM), random access memory (RAM), flash ROM, etc. More specifically, for example, flash ROM and ROM store various types of programs, and RAM is used as work area of the CPU 301. Programs stored in the memory 302 are loaded onto the CPU 301, whereby encoded processes are executed by the CPU 301.

The I/F 303 is connected to the network 210 through a communications line and is connected to other computers (e.g., the communications terminal apparatuses 202 depicted in FIG. 2) through the network 210. The I/F 303 administers an internal interface with the network 210 and controls the input and output of data from other computers. A modem, a LAN adapter, and like can be adopted as the I/F 303, for example.

The disk drive 304, under the control of the CPU 301, controls the reading and writing of data with respect to the disk 305. The disk 305 stores data written thereto under the control of the disk drive 304. A magnetic disk, an optical disk, and the like may be adopted for the disk 305, for example. In addition to the components above, the screen control apparatus 201 may further have, for example, a keyboard, a mouse, a display, etc.

FIG. 4 is a block diagram of an example of hardware configuration of the communications terminal apparatuses 202. In FIG. 4, the communications terminal apparatuses 202 respectively have a CPU 401, memory 402, the display 403, a keypad 404, an I/F 405, an audio signal processing unit 406, a speaker 407, and a microphone 408, respectively connected by a bus 400.

Here, the CPU 401 governs overall control of the communications terminal apparatus 202. The memory 402, for example, includes ROM, RAM, and flash ROM. More specifically, for example, flash ROM stores an operating system (OS) program, ROM stores application programs, and RAM is used as a work area of the CPU 401. Programs stored in the memory 402 are loaded onto the CPU 401, whereby encoded processes are executed by the CPU 401.

The display 403 displays data such as documents, images, and functional information in addition to a cursor, icons, and toolboxes. The display 403 is a touch panel display. A liquid crystal display, organic electroluminescence (EL) display, and the like may be used for the display 403, for example. The keypad 404 has keys for inputting text, numerals, various instructions, etc., and inputs data.

The I/F 405 is connected to the network 210 through a communications line and is connected to other computers (e.g., the screen control apparatus 201) through the network 210. The I/F 405 administers an internal interface with the network 210 and controls the input and output of data from other computers.

The audio signal processing unit 406 is connected to the speaker 407 and the microphone 408. For example, sound received by the microphone 408 is A/D converted by the audio signal processing unit 406. Further, sound is output from the speaker 407.

Although not depicted, in addition to the components above, the communications terminal apparatuses 202, for example, may have respectively a power management unit (PMU) that supplies power to the components, a battery, a Global Positioning System (GPS) unit, and the like.

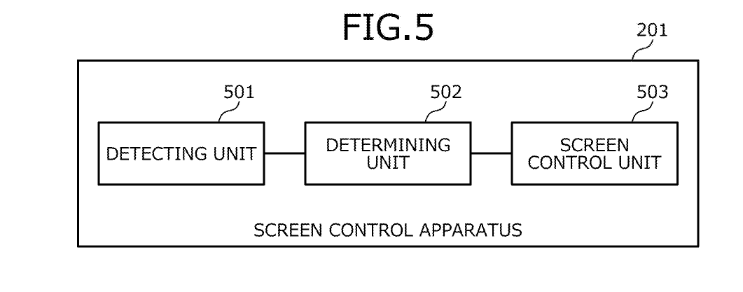

FIG. 5 is a block diagram of an example of a functional configuration of the screen control apparatus 201. In FIG. 5, the screen control apparatus 201 includes a detecting unit 501, a determining unit 502, and a screen control unit 503. The detecting unit 501 to the screen control unit 503 are functions forming a control unit and more specifically, for example, are functions realized by executing on the CPU 301, a program stored in a storage apparatus such as the memory 302 and the disk 305 depicted in FIG. 3, or by the I/F 303. Processing results of the functional units, for example, are stored to a storage apparatus such as the memory 302 and the disk 305.

The detecting unit 501 has a function of detecting a predetermined operation with respect to the communications terminal apparatuses 202, during display of a vertical calendar screen or a lattice calendar screen on the display 403 of the communications terminal apparatuses 202. The predetermined operation, for example, may be a horizontal flick, a diagonal flick, the pressing of a specified button, etc. with respect to the display 403, or may be the pressing of a specified key of the keypad 404.

More specifically, for example, the detecting unit 501 receives from, a communications terminal apparatus 202 displaying a vertical calendar screen or a lattice calendar screen on the display 403, event information concerning a predetermined operation and thereby, detects the predetermined operation of the communications terminal apparatus 202.

In the description hereinafter, as one example of the predetermined operation, a case will be described where a “horizontal flick” is performed with respect to the display 403. Horizontal flicks include a flick toward the right (right flick) and a flick towards the left (left flick).

The determining unit 502 has a function of determining the type of the calendar screen being displayed on the display 403. Types of calendar screens include a vertical calendar screen and a lattice calendar screen. More specifically, for example, the determining unit 502, in response to a detection of a horizontal flick by the detecting unit 501, determines the type of the calendar screen being displayed on the display 403.

Information concerning the calendar screen being displayed on the display 403, for example, may include event information concerning the predetermined operation. Further, information concerning the calendar screen being displayed on the display 403 may be managed at the screen control apparatus 201.

The screen control unit 503 has a function of performing screen control of the display 403. For example, based on a determination result of the determining unit 502, the screen control unit 503 performs screen control to change the date of the calendar screen to be displayed, by a changing scheme that differs according to the type of the calendar screen being displayed on the display 403.

More specifically, the screen control unit 503, when a horizontal flick is detected during display of a vertical calendar screen, performs screen control of changing from the date of the displayed information to a date before the date of the displayed information, by the interval T1, or a data after the date of the displayed information, by the interval T1. As described above, the interval T1 is an interval that differs from the interval T2, and can be arbitrarily set.

Further, when a horizontal flick is detected during display of a lattice calendar screen, the screen control unit 503 performs screen control of changing to a date of a month that is before the month of the displayed information, by the interval T2, or a date of a month that is after the month of the displayed information, by the interval T2. As described above, the interval T2 is an interval that differs from the interval T1, and can be arbitrarily set.

In the description hereinafter, a case where the interval T1 is set as “1 year”, and the interval T2 is set as “1 month” will be described as an example.

In this case, when a right flick is detected during display of a vertical calendar screen, the screen control unit 503 performs screen control of changing to the same month and day of the previous year, the same month and day of as that of the vertical calendar screen being displayed. Further, when a left flick is detected during display of a vertical calendar screen, the screen control unit 503 performs screen control of changing to the same month and day of the subsequent year.

When a right flick is detected during display of a lattice calendar screen, the screen control unit 503 performs screen control of changing to a date of the month before the month of the lattice calendar screen being displayed. Further, when a left flick is detected during display of a lattice calendar screen, the screen control unit 503 performs screen control of changing to a date of the month after the month of the displayed information.

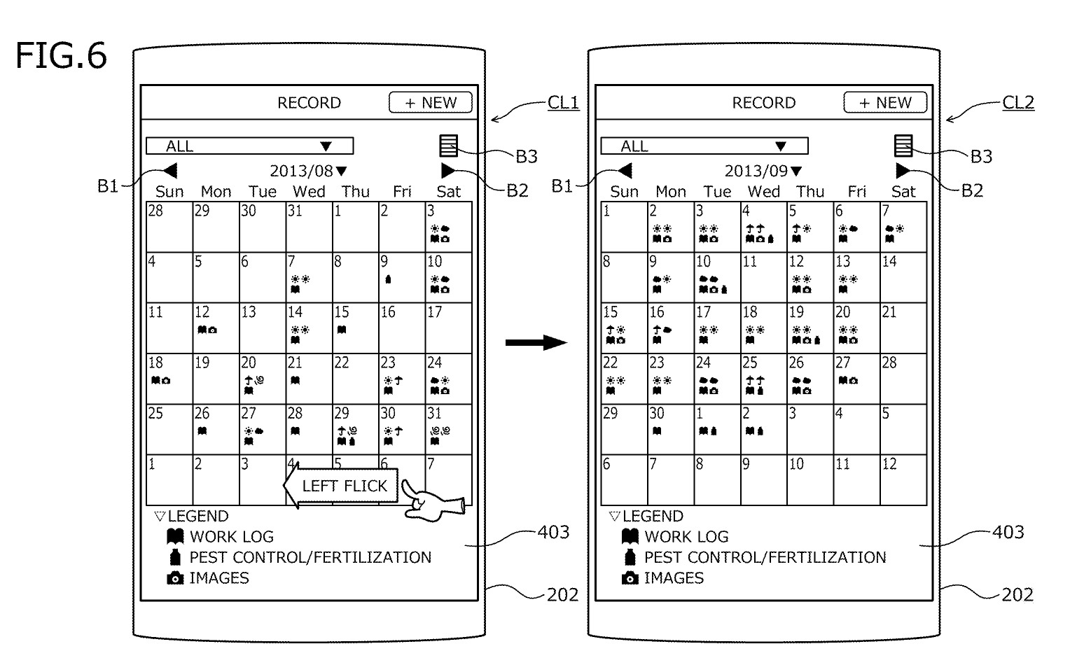

An example of transition of the calendar screen displayed by the display 403 of a communications terminal apparatus 202 will be described with reference to FIGS. 6 to 9.

FIGS. 6, 7, 8, and 9 are diagrams depicting an example of calendar screen transition. In FIG. 6, the display 403 of the communications terminal apparatus 202 displays a lattice calendar screen CL1 in which general information for days in “2013/08” (AUGUST 2013) is entered.

More specifically, the lattice calendar screen CL1 indicates by icons, the weather, existence of work logs, performance of farm work, existence of images, etc. for days in “2013/08”. A work log is an entry of information related to farm work of a given day. In a vertical calendar screen, a portion of or all of the contents of a work log is displayed. Icons representing farm work, for example, include icons representing pest control/fertilization, irrigation, staking, foliar feeding, pesticide application, fertilizer application, etc.

The lattice calendar screen CL1 enables the user to comprehend general information for each day in “2013/08”. For example, concerning “2013/08/24”, the user can know that the weather was cloudy followed by clear skies, a work log exists in which information related to farm work is entered, and field and crop images exist.

When the user left flicks the lattice calendar screen CL1, a lattice calendar screen CL2 is displayed on the display 403. More specifically, for example, when the user left flicks the lattice calendar screen CL1, the communications terminal apparatus 202 transmits to the screen control apparatus 201, event information concerning the left flick.

The screen control apparatus 201, upon receiving the event information, detects the left flick during the display of the lattice calendar screen CL1. The screen control apparatus 201 generates screen information for a lattice calendar screen for “2013/09”, which is the month subsequent to “2013/08”, and transmits the screen information to the communications terminal apparatus 202.

The communications terminal apparatus 202, upon receiving the screen information from the screen control apparatus 201, outputs the received screen information to the display 403. As a result, the lattice calendar screen CL2 in which general information for days in “2013/09” is entered is displayed on the display 403.

For example, when a button B1 is touched in the lattice calendar screen CL1, a lattice calendar screen for “2013/07” can be displayed on the display 403. Further, when a button B2 is touched in the lattice calendar screen CL1, similar to a left flick, the lattice calendar screen CL2 for “2013/09” can be displayed on the display 403.

The lattice calendar screen CL2 enables the user to comprehend general information for days in “2013/09”. For example, concerning “2013/09/26”, the user can know that the weather was cloudy, a work log exists in which information related to farm work is entered, and field and crop images exist.

Here, the user is assumed to touch “09/26” in the lattice calendar screen CL2 to display a vertical calendar screen for “2013/09/26”.

In this case, the communications terminal apparatus 202, for example, transmits to the screen control apparatus 201, event information concerning the touching of “2013/09/26”. The screen control apparatus 201, upon receiving the event information, generates screen information for the selection of “09/26” in the lattice calendar screen CL2 and transmits the screen information to the communications terminal apparatus 202.

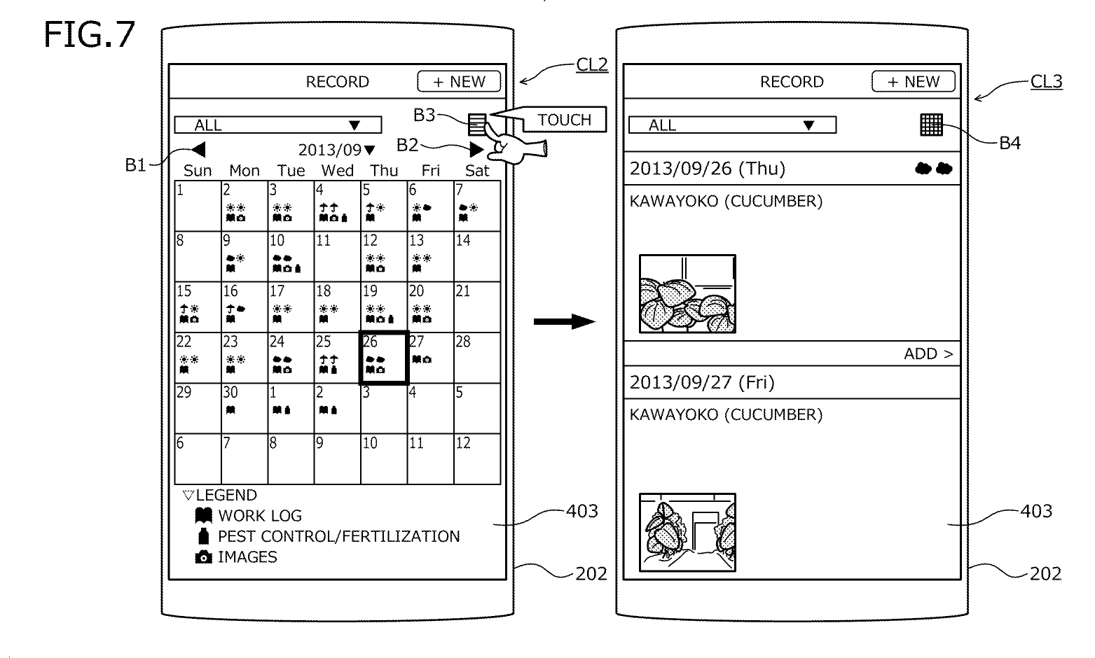

The communications terminal apparatus 202, upon receiving the screen information from the screen control apparatus 201, outputs the received screen information to the display 403. As a result, the lattice calendar screen CL2 in which “2013/09/26” is selected is displayed on the display 403 (refer to FIG. 7).

In FIG. 7, the lattice calendar screen CL2 in which “2013/09/26” is selected is displayed on the display 403. When the user touches button B3 in the lattice calendar screen CL2, the type of calendar screen to be displayed on the display 403 is switched from a lattice calendar screen to a vertical calendar screen.

More specifically, for example, the communications terminal apparatus 202 transmits to the screen control apparatus 201, event information concerning the touching of button B3. The screen control apparatus 201, upon receiving the event information, generates screen information for a vertical calendar screen for “2013/09/26” and transmits the screen information to the communications terminal apparatus 202.

The communications terminal apparatus 202, upon receiving the screen information from the screen control apparatus 201, outputs the received screen information to the display 403. As a result, a vertical calendar screen CL3 for “2013/09/26” is displayed on the display 403.

The vertical calendar screen CL3 enables the user to comprehend specific information related to farm work of “2013/09/26”. For example, the user can know that a field and crop under cultivation on “2013/09/26” is “Kawayoko (cucumber)”, and can further know the state of growth of the crop from an image.

In the example of the vertical calendar screen CL3, since the amount of information concerning “2013/09/26” is minimal, information concerning “2013/09/27” is further displayed on the display 403 subsequent to that concerning “2013/09/26”.

Here, the user is assumed to reference a vertical calendar screen for “2012/09/26”, one year before to confirm farm work to be performed on “2013/09/26”.

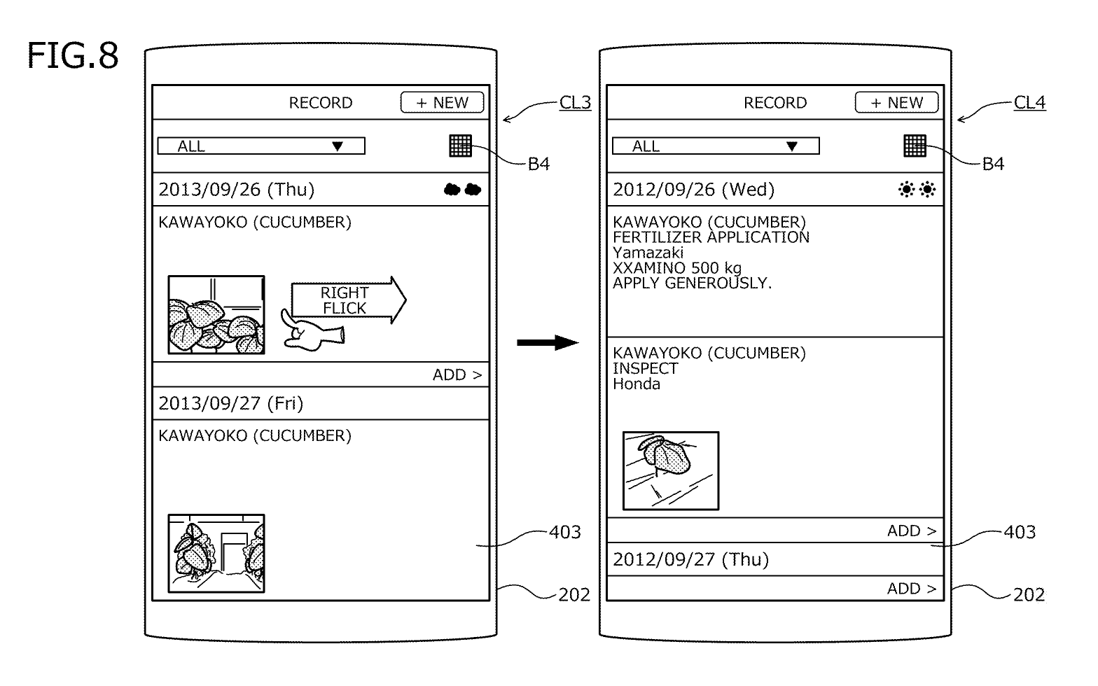

In FIG. 8, the vertical calendar screen CL3 in which specific information related to farm work on “2013/09/26” is input is displayed on the display 403. When the user right flicks the vertical calendar screen CL3, a vertical calendar screen CL4 is displayed on the display 403. More specifically, for example, when the user right flicks the vertical calendar screen CL3, the communications terminal apparatus 202 transmits to the screen control apparatus 201, event information concerning the right flick.

The screen control apparatus 201, upon receiving the event information, detects the right flick during the display of the vertical calendar screen CL3. The screen control apparatus 201 generates screen information for a vertical calendar screen for “2012/09/26”, which is the same day, one year before “2013/09/26” and transmits the screen information to the communications terminal apparatus 202.

The communications terminal apparatus 202, upon receiving the screen information from the screen control apparatus 201, outputs the received screen information to the display 403. As a result, the vertical calendar screen CL4 in which specific information related to farm work on “2012/09/26” is input is displayed on the display 403. Thus, the user can cause the vertical calendar screen CL4 of a date one year before to be displayed on the display 403 by a single operation of right flicking the vertical calendar screen CL3.

The vertical calendar screen CL4 enables the user to know specific information related to farm work on “2012/09/26”. For example, the user can know that a crop under cultivation on “2012/09/26” is “Kawayoko (cucumber)”, and a worker “Yamazaki” “applied fertilizer”. Further, the user can know that the applied fertilizer was 500 kg of “xxamino”, which was applied “generously”. “xxamino” is the name of the fertilizer.

Thus, the user can know that on “2013/09/26”, in the field “Kawayoko (cucumber)”, the farm work to be performed is “fertilizer application”. Further, the user can know that the fertilizer to be used is “xxamino” and for this interval, about 500 kg of the fertilizer should be generously applied.

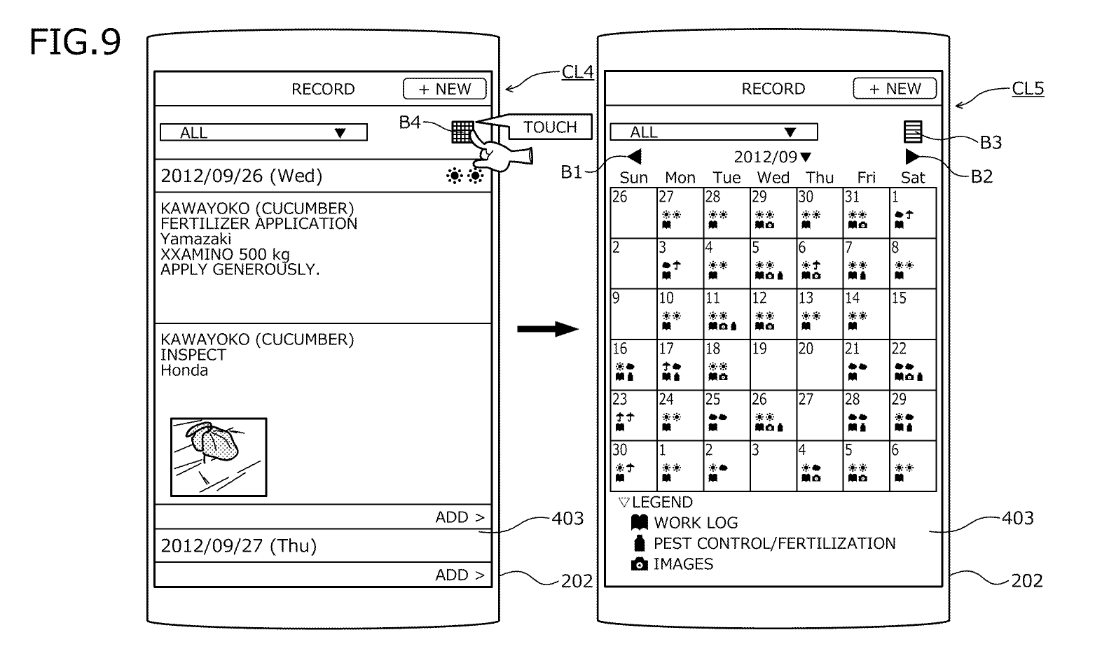

Further, as depicted in FIG. 9, when the user touches a button B4 in the vertical calendar screen CL4, the type of the calendar screen displayed on the display 403 can be switched from a vertical calendar screen to a lattice calendar screen. More specifically, for example, when the user touches button B4 in the vertical calendar screen CL4, the communications terminal apparatus 202 transmits to the screen control apparatus 201, event information concerning the touching of button B4.

The screen control apparatus 201, upon receiving the event information, for example, generates and transmits to the communications terminal apparatus 202, screen information of a lattice calendar screen for the same year and month “2012/09” as that of the vertical calendar screen CL4 being displayed. The communications terminal apparatus 202, upon receiving the screen information from the screen control apparatus 201, outputs the received screen information to the display 403. As a result, a lattice calendar screen CL5 for “2012/09” is displayed on the display 403.

In the example depicted in FIG. 9, although the vertical calendar screen CL4 is depicted to be switched to the lattice calendar screen CL5 for the same year and month “2012/09” as that of the vertical calendar screen CL4, configuration is not limited hereto. For example, the screen control apparatus 201 may transmit to the communications terminal apparatus 202 as the calendar screen to be switched to from the vertical calendar screen CL4, the screen information for the lattice calendar screen CL2 that was displayed before the vertical calendar screen CL4.

As a result, the lattice calendar screen CL2 for “2013/09” is displayed on the display 403 and thus, for example, when the user wants to confirm the farm work that is to be performed on “2013/09/27” after that on “2013/09/26”, “09/27” on the lattice calendar screen CL2 can be selected immediately.

Further, in the example depicted in FIG. 7, although the lattice calendar screen CL2 is depicted to have been switched to the vertical calendar screen CL3 for “2013/09/26” selected by a user operation, there may be cases where no day is selected in the lattice calendar screen CL2. In such a case, the screen control apparatus 201 may generate and transmit to the communications terminal apparatus 202 as the subsequent calendar screen of the lattice calendar screen CL2, screen information for a vertical calendar screen for a day (for example, first day, intermediate day, last day, etc.) in the lattice calendar screen CL2.

A procedure of a screen control process of the screen control apparatus 201 will be described. Here, dates of calendar screens will be denoted as “x_year/y_month/z_day”.

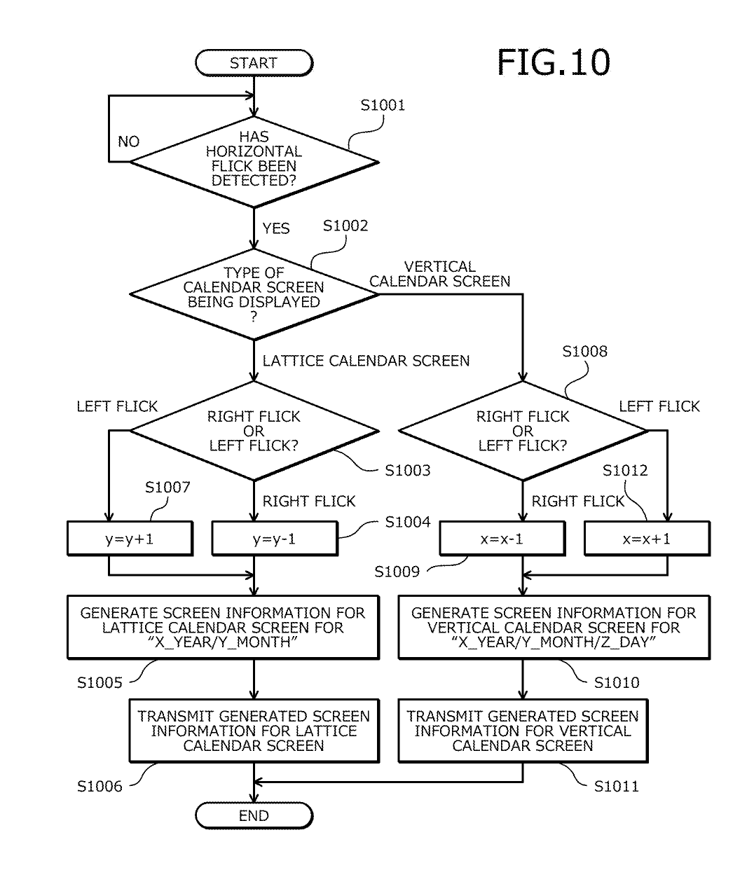

FIG. 10 is a flowchart of the screen control process of the screen control apparatus 201. In the flowchart depicted in FIG. 10, the screen control apparatus 201 determines whether a horizontal flick has been detected during display of a vertical calendar screen or a lattice calendar screen on the display 403 of a communications terminal apparatus 202 (step S1001).

Here, the screen control apparatus 201 waits for detection of a horizontal flick (step S1001: NO). When a horizontal flick has been detected (step S1001: YES), the screen control apparatus 201 determines whether the type of the calendar screen being displayed on the display 403 is a lattice calendar screen or a vertical calendar screen (step S1002).

In the case of a lattice calendar screen (step S1002: lattice calendar screen), the screen control apparatus 201 determines whether the horizontal flick is a right flick or a left flick (step S1003). In the case of a right flick (step S1003: right flick), the screen control apparatus 201 decrements “y” of the year and month “x_year/y_month” of the displayed lattice calendar screen (step S1004).

The screen control apparatus 201 generates screen information for a lattice calendar screen for “x_year/y_month” (step S1005), and transmits the generated screen information for the lattice calendar screen to the communications terminal apparatus 202 (step S1006), ending a series of operations according to the flowchart.

At step S1003, in the case of a left flick (step S1003: left flick), the screen control apparatus 201 increments “y” of the year and month “x_year/y_month” of the displayed lattice calendar screen (step S1007), and transitions to step S1005.

At step S1002, in the case of a vertical calendar screen (step S1002: vertical calendar screen), the screen control apparatus 201 determines whether the horizontal flick is a right flick or a left flick (step S1008). In the case of a right flick (step S1008: right flick), the screen control apparatus 201 decrements “x” of the date “x_year/y_month/z_day” of the displayed vertical calendar screen (step S1009). When the date of the displayed calendar screen is 02/29 of a leap year, the screen control apparatus 201 may decrement “x” and change the month and day to 03/01.

The screen control apparatus 201 generates screen information for a vertical calendar screen for “x_year/y_month/z_day” (step S1010), and transmits the generated screen information for the vertical calendar screen to the communications terminal apparatus 202 (step S1011), ending a series of operations according to the flowchart.

At step S1008, in the case of a left flick (step S1008: left flick), the screen control apparatus 201 increments “x” of the date “x_year/y_month/z_day” of the displayed vertical calendar screen (step S1012), and transitions to step S1010. When the date of the displayed calendar screen is 02/29 of a leap year, the screen control apparatus 201 may increment “x” and change the month and day to 03/01.

As a result, when a horizontal flick is detected during display of a vertical calendar screen or a lattice calendar screen, the date of the calendar screen to be displayed can be changed by a changing scheme that differs according to whether the calendar screen being displayed is a vertical calendar screen or a lattice calendar screen.

As described above, according to the screen control apparatus 201 of the second embodiment, a predetermined operation of a communications terminal apparatus 202 displaying a vertical calendar screen or a lattice calendar screen on the display 403 of the communications terminal apparatus 202 can be detected. Further, according to the screen control apparatus 201, when a predetermined operation is detected during display of a vertical calendar screen, screen control of changing to a date that is before the date of the display information, by the interval T1, or a date that is after the date of the displayed vertical calendar screen, by the interval T1 can be performed. Further, according to the screen control apparatus 201, when a predetermined operation is detected during display of a lattice calendar screen, screen control of changing to a date of a month that is before the month of the displayed lattice calendar screen, by the interval T2, which differs from the interval T1, or a date of a month that is after the month of the displayed lattice calendar screen, by the interval T2, can be performed.

As a result, when a predetermined operation is detected during display of a vertical calendar screen or a lattice calendar screen, the date of the calendar screen to be displayed can be changed by a changing scheme that differs depending on whether the displayed calendar screen is a vertical calendar screen or a lattice calendar screen.

According to the screen control apparatus 201, when a predetermined operation is detected during display of a vertical calendar screen, screen control of changing to the same month and day of the previous year or the subsequent year can be performed. As a result, for example, concerning a crop cultivated every year, during display of a vertical calendar screen referenced to know information of the previous year or before, information of the same interval of another year can be output to the screen by fewer operations.

According to the screen control apparatus 201, when a predetermined operation is detected during display of a lattice calendar screen, screen control of changing to a date of the month before or a date of the month after the month of the displayed lattice calendar screen can be performed. As a result, for example, during display of a lattice calendar screen referenced to know general information for days before and after the current date, past information or information for the near future can be output to the screen by fewer operations.

Further, according to the screen control apparatus 201, a horizontal flick can be detected as a predetermined operation during display of a vertical calendar screen or a lattice calendar screen. As a result, the date of a vertical calendar screen or a lattice calendar screen can be changed by the same intuitive operation.

Thus, according to the screen control apparatus 201, when a lattice calendar screen and a vertical calendar screen are used based on respective traits thereof to reference different information, fewer operations are performed until the information of a specified date desired by the user is displayed, enabling improved user convenience. Further, since fewer operations are performed until the information of a specified date desired by the user is displayed, the processing load of the screen control apparatus 201 for display control of the communications terminal apparatuses 202 is reduced, enabling power consumption to be suppressed.

The screen control method described in the present embodiment may be implemented by executing a prepared program on a computer such as a personal computer and a workstation. The screen control program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect of the present disclosure, an effect is achieved in that the scheme of changing the date of a calendar screen in response to a given operation can be changed depending on the type of the calendar screen being displayed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium storing therein a screen control program that causes a computer to execute a process comprising:
performing when a predetermined operation is detected during display of a first calendar screen or a second calendar screen, screen control of changing a date of a calendar screen to be displayed, by a changing scheme that differs according to whether a displayed calendar screen is the first calendar screen or the second calendar screen, wherein
the computer is configured to switch display of the first calendar screen by which dates are aligned chronologically in a vertical direction enabling scrolling and the second calendar screen in which the dates are arranged according to days of a week in a horizontal direction and chronologically in a vertical direction in a lattice.

2. The non-transitory, computer-readable recording medium according to claim 1, wherein
the performing the screen control includes:
changing to a date that is a first interval before or after a date of the displayed calendar screen, when the predetermined operation is detected during display of the first calendar screen, and
changing to a date of a month that is a second interval, which is different from the first interval, before or after a month of the displayed calendar screen, when the predetermined operation is detected during display of the second calendar screen.

3. The non-transitory, computer-readable recording medium according to claim 2, wherein
the performing the screen control includes:
changing to a same month and day of a previous year or subsequent year, when the predetermined operation is detected during display of the first calendar screen, the same month and day being a month and day of the displayed calendar screen, and
changing to a previous month or a subsequent month of the month of the displayed calendar screen, when the predetermined operation is detected during display of the second calendar screen.

4. The non-transitory, computer-readable recording medium according to claim 1, wherein
the performing the screen control includes detecting as the predetermined operation, a horizontal flick during display of the first calendar screen or the second calendar screen.

5. A screen control apparatus comprising
a control circuit configured to perform when a predetermined operation is detected during display of a first calendar screen or a second calendar screen, screen control of changing a date of a calendar screen to be displayed, by a changing scheme that differs according to whether a displayed calendar screen is the first calendar screen or the second calendar screen, wherein
the control circuit is further configured to switch display of the first calendar screen by which dates are aligned chronologically in a vertical direction enabling scrolling and the second calendar screen in which the dates are arranged according to days of a week in a horizontal direction and chronologically in a vertical direction in a lattice.

6. A screen control method comprising:
performing by a computer when a predetermined operation is detected during display of a first calendar screen or a second calendar screen, screen control of changing a date of a calendar screen to be displayed, by a changing scheme that differs according to whether a displayed calendar screen is the first calendar screen or the second calendar screen, wherein
the computer is configured to switch display of the first calendar screen by which dates are aligned chronologically in a vertical direction enabling scrolling and the second calendar screen in which the dates are arranged according to days of a week in a horizontal direction and chronologically in a vertical direction in a lattice.
